(19) United States
(12) Patent Application Publication
(10) Pub. No.: US 2011/0011330 A1
(43) Pub. Date: Jan. 20, 2011

(54) Dual-Temperature, Sealed-System Critical Temperature Indicator

(75) Inventors: Albert J. Moses, West Chester, PA (US); Michael E. Drummond, Broomall, PA (US)

Correspondence Address: Ryder, Lu, Mazzeo & Konieczny LLC, PO Box 387, CONSHOHOCKEN, PA, 19428-0387, US

(73) Assignee: Drummond Scientific Company, Broomall, PA (US)

(21) Appl. No.: 12/506,248

(22) Filed: Jul. 20, 2009

(51) Int. Cl. G01K 1/02

(52) U.S. Cl. 116/216

(57) ABSTRACT

An inexpensive, disposable apparatus that visually indicates whether an object has been exposed to either one or both of two predetermined critical temperatures such as a critical high T1 or a critical low T2 temperature. The apparatus includes a housing having a reservoir portion, and a capillary tube portion with a first, proximal end in fluid connection with the reservoir portion and an open, second, distal end. A first fluid is contained within the reservoir portion and a portion of the proximal capillary tube portion. A second fluid is contained within the capillary portion intermediate the first fluid and the distal end. A barrier is located intermediate the first fluid and the second fluid. The barrier prevents the first and second fluids from intermixing until the apparatus is exposed to T1 and then allows at least a portion of the second fluid to mix with the first fluid when the apparatus is exposed to T1 and irreversibly changes an observable characteristic of the second fluid. An indicator material is fixed proximate to and in fluid communication with the distal end of the capillary tube portion. The indicator material has an observable characteristic that irreversibly changes at T2 when contacted with the second fluid. An outer sheath encapsulates the indicator and the distal open end of the capillary tube portion to prevent the fluids and barrier from evaporating from the housing.

### FIELD OF THE INVENTION

The present invention relates to an inexpensive, disposable apparatus that visually indicates whether an object has been exposed to either one or both of two predetermined critical temperatures such as a critical high or critical low temperature.

### BACKGROUND OF THE INVENTION

Some pharmaceuticals, reagents, diagnostic tests, and other products require refrigerated storage for preservation. However, exposure to conditions below recommended temperatures, usually the freezing point of an aqueous solution, may change the operating characteristics of the product or render the product useless for its intended purpose. For this reason, many objects are packaged with a low-temperature indicator, which alerts the end user if the product has been exposed to conditions below the recommended critical temperature.

Likewise, some pharmaceuticals, reagents, diagnostic tests, and other products can be adversely impacted or spoiled if exposed to a temperature above a recommended critical temperature. For this reason, said products are packaged with a high-temperature indicator, which alerts the end user if the product has been exposed to conditions above the recommended critical temperature.

Furthermore, some pharmaceuticals, reagents, diagnostic tests, and other products can also be adversely impacted or spoiled if exposed to a temperature above or below a narrowly defined range. For example, some hematology controls for evaluating the accuracy and precision of hematology analyzers must be shipped at storage temperatures of about 2° C. to about 30° C. or degradation of the reagents occurs. Blood analysis cartridges used in blood analyzers used for measurement of blood pH, pC0₂, 0₂, Hct, Na+, K+, iCa are typically stored at 15° C. to 30° C. If the cartridge is exposed to temperatures outside this range, degradation and decomposition and/or reduced sensitivity of the reagents may occur. Transport tubes containing urine specimens used for in-vitro diagnostic use must be stored at between 2° C. and 30° C. to prevent degradation of the sample and reduced test sensitivity.

The prior art discloses numerous inexpensive, disposable devices that indicate exposure to a single critical temperature, either high or low. For example, one known type of low-temperature indicator is disclosed by Drummond et al., U.S. Pat. No. 7,475,653, incorporated herein by reference, which discloses a sealed-system indicator that gives a visual indication if the object has been exposed to a predetermined critical low temperature below the freezing point of the object. Drummond's indicator, however, does not appear to be able to provide a visual indication if the product has also been exposed to a predetermined high temperature. Therefore, it would be desirable to provide an inexpensive, disposable device that provides a visual indication if a product has been exposed to either of a critical high temperature or critical low temperature, or both.

### BRIEF DESCRIPTION OF THE DRAWINGS

FIG. 1 is a side elevational view of a dual-temperature, critical temperature indicator in accordance with an embodiment of the invention;

FIG. 2 is a cross-sectional view taken along lines 2-2 of FIG. 1;

FIG. 3 is an enlarged, fragmentary sectional view (not to scale) of the upper section of the capillary tube portion of the critical temperature indicator shown in FIG. 1;

FIG. 4 is an enlarged, fragmentary, sectional view of the reservoir portion/capillary tube portion junction of the housing;

FIG. 5 is an enlarged, fragmentary, sectional view (not to scale) the upper section of the capillary portion of the housing during an initial filling step of the second reagent fluid;

FIG. 6 is an enlarged, fragmentary, sectional view (not to scale) of the upper section of the capillary portion of the housing during a secondary filling step of the second reagent fluid;

FIG. 7 is an exploded, sectional view showing assembly of the housing and sheath;

FIG. 8 is a cross-sectional view of a dual-temperature, critical temperature indicator in accordance with another embodiment of the invention;

FIG. 9 is a cross-sectional view of a dual-temperature, critical temperature indicator in accordance with a further embodiment of the invention;

FIG. 10 is a fragmentary, cross-sectional view of a dual-temperature, critical temperature indicator in accordance with yet another embodiment of the invention;

FIG. 11 is a fragmentary side elevational view of a dual-temperature, critical temperature indicator in accordance with yet a further embodiment of the invention; and,

FIG. 12 is a fragmentary cross-sectional view of a dual-temperature, critical temperature indicator in accordance with an additional embodiment of the invention.

### SUMMARY OF THE INVENTION

The present invention relates to an inexpensive, disposable apparatus that visually indicates whether an object has been exposed to either one or both of two predetermined critical temperatures such as a critical high or critical low temperature. The apparatus may be attached to or located proximate to an object, and gives a visual indication of whether the apparatus, and hence the object, has been exposed to a first predetermined critical temperature T1, a second predetermined critical temperature T2, or both T1 and T2. For example, if the object, such as a hematology control, has a storage or shipment temperature range of 2° C. to 30° C., the apparatus provides a visual indication if the object has been exposed to a temperature of 2° C. or lower, i.e., the critical lower temperature T1. The apparatus also provides a visual indication if the object has been exposed to a temperature of 20° C. or higher, i.e., the critical upper temperature T2. The apparatus provides two separate visual indicators, one for T1 and the other for T2. The critical temperatures T1 and T2 of the apparatus can be varied by selecting different reagent fluids and structural design dimensions.

In a preferred embodiment, the apparatus has a housing with a reservoir portion, and a capillary tube portion with a first, proximal end in fluid connection with the reservoir portion and an open, second, distal end. A first reagent fluid is contained within the reservoir portion and a portion of the proximal capillary tube portion. A second reagent fluid is contained within the capillary portion intermediate the first fluid and the distal end. A barrier is located intermediate the first fluid and the second fluid. The barrier prevents the first and second fluids from intermixing until the apparatus is exposed to T1, and then allows at least a portion of the second fluid to mix with the first fluid when the apparatus is exposed to T1 and irreversibly changes an observable characteristic of the second fluid.

An upper-temperature indicator material is fixed proximate to and in fluid communication with the distal end of the capillary tube portion. The indicator material has an observable characteristic that irreversibly changes when contacted with the second fluid. An expansion space is located in the capillary tube portion intermediate the second fluid and the indicator material. The indicator material preferably comprises a first porous plug having an outer diameter slightly larger than the inner diameter of the capillary tube portion. In a preferred embodiment, the porous plug is made from sintered polyethylene.

An outer sheath encapsulates the indicator material and the distal open end of the capillary tube portion to prevent the fluids and barrier from evaporating from the housing. A sealed cavity is located intermediate the sheath and the indicator material. In one embodiment, the sheath encapsulates the entire length of said capillary tube portion of the housing. In another embodiment, the sheath only encapsulates a the upper portion of the capillary tube but still encapsulates the indicator material and the open distal end of the capillary tube.

When the apparatus is exposed to the lower critical temperature T1, the volume of the first reagent fluid within the reservoir portion reduces in volume an amount sufficient to draw at least a portion of the second reagent fluid into the reservoir portion and to mix with the first reagent fluid, thereby irreversibly changing an observable characteristic, such as color, of the first reagent fluid. When the apparatus is exposed to the upper critical temperature T2, the volume of the first reagent fluid within the bulb expands an amount sufficient to expel at least a portion of the second reagent fluid into contact with the indicator material fixed proximate to and in fluid communication with the distal, free end of the capillary tube, thereby irreversibly changing an observable characteristic, such as color, of the indicator material.

In another embodiment, the apparatus includes at least a second plug axially aligned and spaced from the first plug. Each of the multiple plugs changes color at a different, sequentially-higher, critical temperature so that the apparatus also indicates the amount by which the upper critical temperature was exceeded.

In yet another embodiment, the apparatus includes a plurality of indicia axially-arranged along the length of the plug that correlate with known absorption time intervals of the plug. Knowing the wicking rate of the second fluid through the plug, the indicia also indicate the length of time that has past since the indicator was first exposed to the upper critical temperature.

In a further embodiment, a first length of the capillary tube portion has a first inner diameter and a second portion has a second inner diameter different than the first inner diameter. This design is useful when the difference between the lower and upper critical temperatures is very large or very small.

### DETAILED DESCRIPTION OF PREFERRED EMBODIMENT(S)

For the purpose of illustration, there is shown in the accompanying drawings several embodiments of the invention. However, it should be understood by those of ordinary skill in the art that the invention is not limited to the precise arrangements and instrumentalities shown therein and described below.

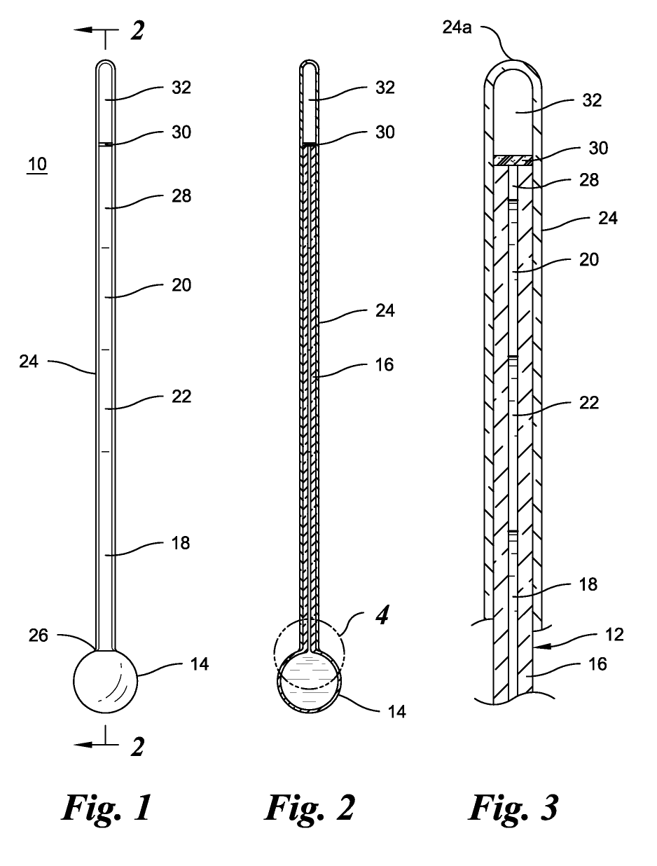

An apparatus that indicates whether an object has been exposed to at least one of a lower, predetermined critical temperature T1 and an upper, predetermined critical temperature T2 higher than T1 in accordance with a first embodiment of the invention is shown in FIGS. 1-7 and is designated generally by reference numeral 10. The apparatus 10 has a transparent housing 12, which generally comprises a reservoir portion 14 and a capillary tube portion 16. In a first embodiment illustrated in FIGS. 1-7, the housing 12 is formed from a single piece of glass capillary tube. The reservoir portion 14 is integrally formed at one end of the tube and has a bulbous shape. The reservoir portion or bulb 14 is enclosed except for an opening that communicates with the capillary tube portion 16. The capillary tube portion or capillary tube 16 is generally straight and has an opening at the distal end (relative to the bulb 14).

The housing 12 may be formed using known techniques for making liquid thermometer housings. In the embodiments illustrated in FIGS. 1-7, the housing 12 is about 1-2 in. (2.5-5.0 cm.) in length. However, the housing 12 could be longer or shorter depending on practical packaging considerations.

The housing 12 may be made from other types of hydrophilic tubing, such as plastic, depending on the particular reagent fluid and barrier fluids selected for inclusion in the housing 12. If the housing 12 is not made of glass, the substitute material must be resistant to attack by the reagent fluids and the barrier fluid.

Further, if the housing is not made of glass, a material should be selected that does not have capillarity that is significantly greater than the capillarity of glass. Materials that have a high level of “capillarity” also have a high number of nucleating sites, which cause barrier segmentation. Additionally, no matter what the material, the reservoir portion, and preferably the entire housing, should be transparent so that the color change of the first reagent fluid is observable.

With reference to the orientation shown in FIG. 1, a first reagent fluid 18 fills the bulb 14 and a lower portion of the capillary tube 16. A second reagent fluid 20 is contained within an upper portion of the capillary tube 16. A barrier fluid 22 is located intermediate the first and second fluid. The aforementioned fluid levels are at room temperature. The barrier fluid 22 prevents the first and second reagent fluids from intermixing until the device is exposed to the lower critical temperature T1. When the apparatus 10 is exposed to T1, the volume of the first fluid 18 within the bulb 14 reduces in volume an amount sufficient to draw at least a portion of the second reagent fluid 20 into the bulb 14 and to mix with the first reagent fluid 18, thereby irreversibly changing an observable characteristic, such as color, of the first reagent fluid. When the apparatus 10 is exposed to the upper critical temperature T2, the volume of the first reagent fluid 18 within the bulb 14 expands an amount sufficient to expel at least a portion of the second reagent fluid 20 into contact with an upper-temperature indicator material fixed proximate to and in fluid communication with the distal, free end of the capillary tube 16, thereby irreversibly changing an observable characteristic, such as color, of the indicator material.

In the embodiment shown in FIGS. 1-7, the upper-temperature indicator material comprises a porous plug 30, which is held in abutting contact with the open end of the capillary tube 16 by an outer sheath that encapsulates the plug 30 and the open end of the capillary tube 16. The porous plug 30 is made from sintered polyethylene. However, the plug 30 could comprise any material, which can be easily inserted into the sheath tube 24 and which provides a readily, visually observable and irreversible change in appearance when contacted by the second fluid 20. For example, the plug 30 may be treated with a chemical agent that does not initially discolor the plug 30; however, upon contact with an aqueous or organic solution, the plug 30 becomes colored. In another embodiment the plug 30 plug may be treated with cobalt chloride, which initially turns the plug 30 blue. After the plug 30 contacts the second reagent fluid 22, the plug 30 turns pink. Other agents may be used to treat the plug 30 without departing from the scope of the invention.

Depending on the chemical makeup of the indicator, ambient moisture within the indicator may also initiate a slight change in the appearance of the plug 30. Therefore, the plug 30 may be treated with a deliquescing agent, such as salt, to prevent the plug from changing color until contacted with the second liquid 20.

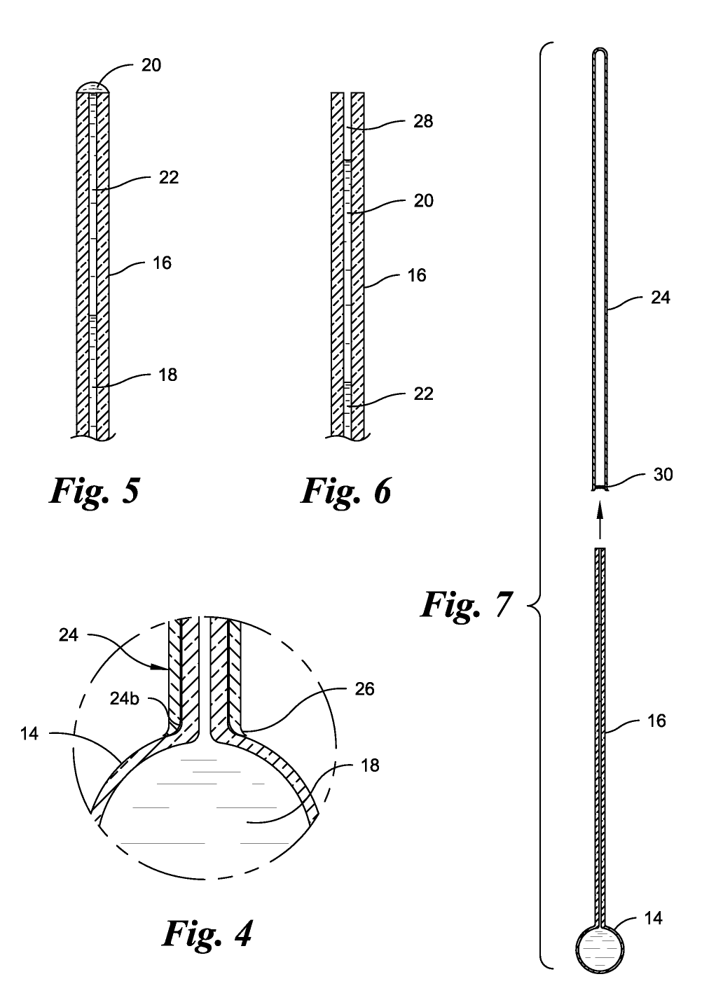

The sheath comprises a glass tube 24 having a sealed distal end 24a (relative to the bulb) and an open proximal end 24b with an outwardly-flared lip as best seen in FIG. 4. The radius of the flared lip approximates the radius of the bulb 14. The inner diameter of the sheath tube 24 is slightly larger than the outer diameter of the capillary tube 16. The length of the sheath tube 24 is greater than the length of the capillary tube 16 so that a sealed cavity 32 is formed on the distal side (relative to the bulb) of the plug 30 when the sheath tube 24 is slid over the capillary tube 14. The sheath tube 24 is preferably fixed on the capillary tube 14 by an adhesive that completely seals the proximal end 24b of sheath tube 24 to the capillary tube 14, which prevents the reactant and barrier fluids within the housing 12 from evaporating.

The plug 30 should have an outer diameter large enough so that friction securely holds the plug at a fixed location within the sheath tube 24 in abutting contact with the open end of the capillary tube 16. In a preferred embodiment, the plug 30 is formed by individually punching a strip of plug material and inserting the punched plugs into the open end of the sheath tube.

The volume (Vᵣ) of the reservoir portion 14 should be greater, preferably much greater, than the volume (V_{c}) of the capillary tube portion 16. It is preferred to maximize the ratio Vᵣ/V_{c} to insure that the second reagent fluid 20 in the capillary tube 16 is drawn by capillary action into the reservoir portion 14 when the first reagent 18 is cooled and/or solidifies upon freezing, and to insure that the second reagent fluid 20 is expelled into contact with the plug 30 when the first reagent fluid is heated. For example, in the embodiment shown in FIGS. 1-7, the volume of the bulb 14 is 50 μl, while the volume of the capillary tube 16 is only about 5 μl.

In a preferred embodiment, the glass tube ratio, i.e., OD/ID ratio, is about 4. The thickness of the glass capillary tube must be balanced to insure that the bulb 14 formed therefrom is strong and uniform. If the capillary tube wall thickness is too thin, the bulbous reservoir will be uniformly fragile. On the other hand, if the capillary tube wall thickness is too thick, the thickness of the wall of the bulbous reservoir will be “loaded”, i.e., one side of the bulb will be much thicker than the other side, thereby forming fragile spots.

In a preferred embodiment, the inner diameter (ID) of the glass capillary tube is about 0.020 and the OD is 0.080 in. Increasing or decreasing the ID can enhance segmenting of the barrier, particularly if the ID is increased. Further, if the ID is too small, then the amount of second reagent fluid 20 that is drawn into the bulb 14 or expelled into the plug 30 is also small and limits the observability of the color change.

Further, if the ID is too small in relation to the reservoir portion 14, then normal temperature fluctuations will prematurely cause the second reagent fluid 20 to be drawn into the reservoir portion 14 (downward temperature flux), or prematurely cause the second reagent fluid 20 to be expelled into the plug (upward temperature flux). Conversely, if the ID is too large in relation to the bulb volume, the volume expansion or reduction of the first reagent fluid 18 upon heating or cooling, respectively, will be insufficient to expel the second reagent fluid into the plug 30, or draw the second reagent fluid into the bulb 14, respectively.

The first reagent fluid 18 should be selected from the group of fluids that exhibit the property of significant volume expansion upon heating and significant reduction upon cooling and especially solidification. Preferably, the first reagent fluid 18 has a volume reduction of about 8 percent or more by volume upon solidification. Reagents exhibiting such reduction upon solidification are believed to also exhibit sufficient volume expansion upon heating. For example, the first reagent fluid 18 may be selected from, or be mixtures of, the following group of fatty acids and organic compounds: octyl caprylate, heptyl caprylate, hexyl laurate, octyl caprate, butyl myristate, isopropyl myristate, decyl caprate, ethyl myristate, isopropyl palmitate, lauryl caprate, butyl stearate, decyl myristate, octadecyl acetate, lauryl palmitate, and cetyl palmitate. In the embodiment shown in FIGS. 1-7, the first fluid is a mixture of octyl capralate and hexyl laurate, which has a solidification temperature of 0° C.

In addition, the first reagent fluid 18 should be selected based on the desired lower T1 and upper T2 intended critical temperatures of the apparatus. Since each of the above-listed fluids solidifies (freezes) at a different temperature ranging from about −1.3° F. (−18.5° C.) to about 120° F. (49° C.), the critical temperatures T1 and T2 of the indicator 10 can be selected within a wide range of temperatures. The first reagent fluid 18 selected for the critical temperature indicator 10 will depend on the critical temperatures of concern to the end user.

The second reagent fluid 20 may be any fluid that is miscible with the first reagent fluid 18 and which has a solidification temperature that is lower than the solidification temperature of the first reagent fluid 18. For example, the second reagent fluid may be selected from, or be mixtures of, the following organic compounds: octyl caprylate, heptyl caprylate, hexyl laurate, octyl caprate, butyl myristate, isopropyl myristate, decyl caprate, ethyl myristate, isopropyl palmitate, lauryl caprate, butyl stearate, decyl myristate, octadecyl acetate, lauryl palmitate, cetyl palmitate, trioctyl phosphate, and bis(2-ethylhexyl)phthalate). In the embodiment shown in FIGS. 1-7, the second reagent fluid 20 comprises octyl caprylate, which has a solidification temperature slightly lower than the first reagent fluid 18.

In a preferred embodiment, a dye is dissolved in the second reagent fluid 20, which discolors the first fluid 18 when the fluids mix The dye may be any water base or organic dye that is compatible with and will dissolve in the second fluid 20. In the embodiments shown in FIGS. 1-7, the dye comprises waxolin violet VA, available from ICI United States, Inc.

The barrier 22 should be immiscible with both the first 18 and second 20 reagent fluids and should have a solidification temperature that is lower than the solidification temperature of the first reagent fluid 18. For example, the barrier 22 may be selected from the following: a saturated solution of nickel II nitrate in water; perfluourocarbon compounds, which are completely fluorinated organic compounds such as those manufactured by the 3M Company under the trademark Fluorinert®; other aqueous solutions of salts such as ammonium chloride, calcium chloride, iron chloride, lithium chloride, potassium bromide, potassium chloride, potassium iodide, sodium bromide, sodium chloride or sodium nitrate; or other glycols or dihydric alcohols such as ethylene glycol. In the embodiment shown in FIGS. 1-7, the barrier 22 comprises ethylene glycol with a green water base food colorant.

It is preferred that the barrier liquid's affinity for glass be minimized so that the number of nucleating sites is reduced. For example, increasing the water content of the ethylene glycol reduces the number of nucleating sites, which reduces barrier breakdown during cycling.

In alternative embodiments of the invention, the barrier 22 may comprises a solid plug of Teflon, wood, or other material so long as the plug is sized to seal but slide within the capillary tube portion 16. However, a liquid barrier 22 is preferred since the liquid helps to clean the glass during cycling.

The volume of the reagent fluids 18, 20 and barrier 22 and the dimensions of the housing are selected so that a hollow expansion space 28 is formed above the second reagent fluid 20. The volume of the hollow expansion space (V_{H}) should equal the change in volume of the first fluid (ΔT_{H}) when the first fluid is elevated from room temperature to the upper critical temperature T2. By equating V_{H} and ΔV_{F1}, the second fluid completely fills the expansion space 28 and contacts the plug 30 once the upper critical temperature T2 is achieved.

The length of the sheath tube 24 should be selected so that the sealed cavity 32 formed on the distal side of the plug 30 is sufficiently large to prevent any vacuum effect on movement of the fluids during cooling and prevent freeze point depression. Similarly, the cavity 32 should be sufficiently large to allow fluid expansion during heating without significant back pressure or breakage of the sheath tube 24. For this reason, the plug 30 should have a porosity sufficient for air to freely migrate between the cavity 32 and the expansion space 28.

FIGS. 5-7 illustrate the method of manufacturing the apparatus in accordance with the invention. Initially, the housing 12 is filled with the first fluid 18 and barrier 22 using known techniques, such as the technique disclosed in Manske, U.S. Pat. No. 4,457,252. For example, the first reagent fluid 18 and barrier fluid 22 may be introduced by alternatively heating and cooling the housing 12 to draw the desired fluid into the housing 12. Next, the entire remaining space within the capillary tube 16 is filled with the second fluid 20. The bulb 14 is then heated to the upper critical temperature T2, which causes some of the second fluid to be expelled from the capillary tube. Any amount of second fluid that pools on the upper end of the capillary tube, as seen in FIG. 5, is aspirated therefrom. The bulb 14 is then allowed to cool to room temperature, which causes a volumetric contraction of the fluids and formation of the hollow expansion space 28 above the second fluid 20. By using this method, V_{H} is equal to ΔV_{F1} as desired.

After the housing is filled, the sheath 24 is applied over the capillary tube 16. Prior to installation, the plug 30 is inserted into the capillary tube 24. The capillary tube is then pushed into the sheath tube to a limit position wherein the open end 24b of the sheath tube 24 contacts the bulb 14. The flared lip at the open end 24b of the sheath tube 24 reduces localized contact stress on the bulb 14 and reduces the chance of cracking the sheath 24 or the bulb 14. As the capillary tube 16 moves inwardly, it abuts the plug 30 and pushes it inwardly towards the sealed end 24a. At the limit position, the plug 30 is precisely positioned within the sheath tube 24 abutting and in fluid communication with the open end of the capillary tube 16. A sealant, such as a UV cured adhesive, is then applied proximate the bulb/sheath end interface.

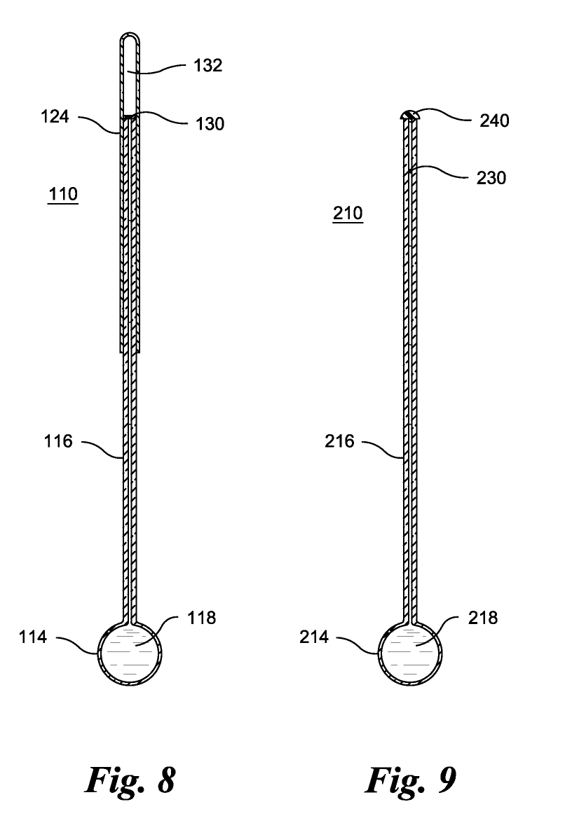

An alternative embodiment of the apparatus is shown in FIG. 8 and is designated generally be reference numeral 110. The indicator has a housing 112 having a reservoir portion 114 and a capillary tube portion 116. First and second reagent fluids within the capillary tube portion are separated by a barrier.

The apparatus 110 is similar in construction and operates similarly to the apparatus 10 described above. However, in this embodiment, the outer sheath 124 covers only the upper, outer portion of the capillary tube 116 but still has a portion that extends beyond the end of the capillary tube 116 so that a sealed cavity 132 is formed on the distal side (relative to the bulb) of the plug 130 when the sheath tube 124 is assembled to the capillary tube 114.

Another embodiment of the invention is shown in FIG. 9 and is designated generally by reference numeral 210. The apparatus has a housing 212 having a reservoir portion 214 and a capillary tube portion 216. First and second reagent fluids within the capillary tube 216 are separated by a barrier.

The apparatus 210 works similarly to the apparatus 10 described above but has no outer sheath. Instead, the plug 230 is inserted in the upper portion of the capillary tube 216. The distal end of the capillary tube 216 is sealed with a cap 240. Alternatively, the end could be heat sealed or sealed with an epoxy or plug.

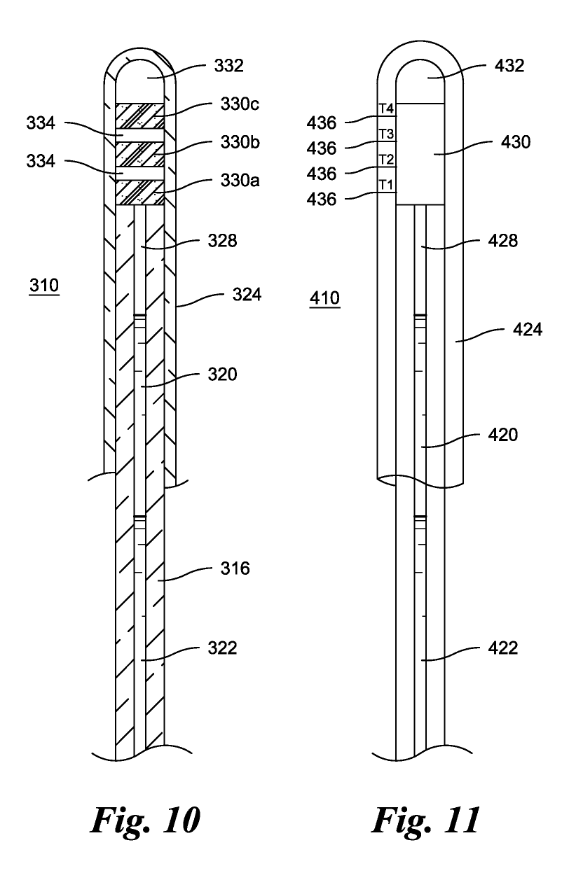

Yet another embodiment of the invention is shown in FIG. 10 and is designated generally be reference numeral 310. The apparatus has a housing 312 having a reservoir portion 314 and a capillary tube portion 316. First and second reagent fluids within the capillary tube portion are separated by a barrier.

The apparatus 310 is similar in construction and operates similarly to the apparatus 10 described above. However, in this embodiment, several plugs 330a, 330b, 330c separated by non-reactive spacers 334 are used in place of the single plug 30 of the first apparatus 10. In this embodiment, each of the multiple plugs 330 changes color at a different, sequentially-higher, critical temperature so that the apparatus also indicates the amount by which the upper critical temperature was exceeded. For example, the apparatus 310 may be designed so that the first plug 330a changes color when the apparatus is heated to T2. Each plug above 330a that has changed color may represent an additional ΔT degrees above T2 to which the apparatus 310 has been exposed.

Still a further embodiment of the invention is shown in FIG. 11 and is designated generally be reference numeral 410. The apparatus has a housing 412 having a reservoir portion 414 and a capillary tube portion 416. First and second reagent fluids within the capillary tube portion are separated by a barrier.

The apparatus 410 is similar in construction and operates similarly to the indicator 10 described above. However, in this embodiment, the plug 430 is much longer axially than the original plug 30 and has a known wicking rate. A series of indicia 436 are imprinted on the exterior of the sheath tube 324 along the length of the plug 430. Based on the wicking rate of the second fluid through the plug 430, the indicia 436 indicate the length of time that has passed since the apparatus was first exposed to the upper critical temperature. For example, T1-T4 may represent hours, days or weeks. By knowing the first exposure time, an end user, such as a shipping service, can backtrack and identify the custodian who caused the apparatus to be exposed to the upper critical temperature.

Still a further embodiment of the invention is shown in FIG. 11 and is designated generally be reference numeral 410. The apparatus has a housing 412 having a reservoir portion 414 and a capillary tube portion 416. First and second reagent fluids within the capillary tube portion are separated by a barrier.

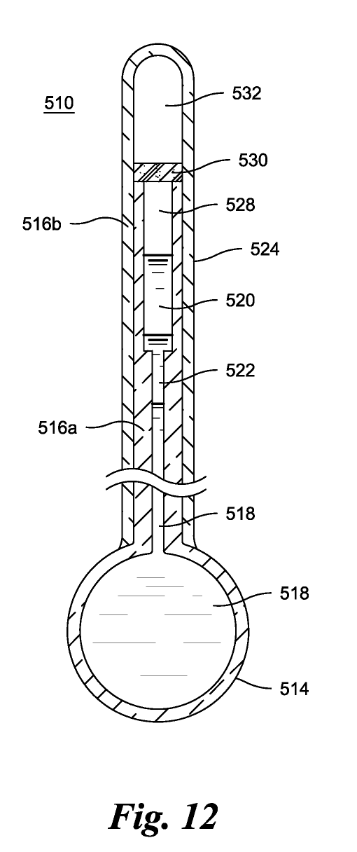

Still another embodiment of the invention is shown in FIG. 12 and is designated generally be reference numeral 510. The apparatus 510 has a housing 512 having a reservoir portion 514 and a capillary tube portion 516. First and second reagent fluids within the capillary tube portion are separated by a barrier.

The apparatus 510 is similar in construction and operates similarly to the apparatus 10 described above. However, in this embodiment, the capillary tube 516 does not have a uniform inner diameter. In this embodiment, the upper portion 516b of the capillary tube has a greater diameter that the lower portion 516a. This design is useful when the difference between the lower and upper critical temperatures is very large and thus requires a large ΔV_{F1}. Instead of making the capillary tube 516 excessively long, the same ΔV_{F1} can be accommodated with a shorter but radially-larger, upper capillary tube section 516b. Conversely, for a very small ΔV_{F1}, the upper section 516b of the capillary tube could have a smaller diameter than the lower portion 516a.

The several embodiments of the invention described are very inexpensive to make but very reliable. Unlike the re-usable electronic dual-temperature indicators of the prior art, the dual-temperature indicator of the present invention can be mass produced at a very low cost and are disposable.

While the principles of the invention have been described above in connection with specific embodiments, it is to be clearly understood that this description is made only by way of example and not as a limitation on the scope of the invention.

1. An apparatus that indicates whether an object has been exposed to at least one of a lower, predetermined critical temperature T1 and an upper, predetermined critical temperature T2 higher than T1, comprising:
a) a housing having a reservoir portion, and a capillary tube portion with a first, proximal end in fluid connection with said reservoir portion and an open, second, distal end;
b) a first reagent fluid contained within said reservoir portion and a portion of the proximal capillary tube portion;
c) a second reagent fluid contained within said capillary portion intermediate said first fluid and the distal end;
d) a barrier located intermediate said first fluid and said second fluid, said barrier preventing said first and second fluids from intermixing until said apparatus is exposed to T1, and then allowing at least a portion of said second fluid to mix with said first fluid when said apparatus is exposed to T1 and irreversibly change an observable characteristic of said second fluid;
e) an indicator material fixed proximate to and in fluid communication with the distal end of the capillary tube portion, said indicator material having an observable characteristic that irreversibly changes when contacted with said second fluid; and,
f) an outer sheath that encapsulates said indicator material and the distal open end of said capillary tube portion to prevent said fluids and barrier from evaporating from said housing.

2. The apparatus recited in claim 1, including an expansion space in said capillary tube portion intermediate said second fluid and said indicator material.

3. The apparatus recited in claim 1, including a sealed cavity intermediate said sheath and said indicator material.

4. The apparatus recited in claim 1, wherein said indicator material comprises a first porous plug having an outer diameter slightly larger than the inner diameter of said capillary tube portion.

5. The apparatus recited in claim 4, wherein said porous plug is made from sintered polyethylene.

6. The apparatus recited in claim 1, wherein said sheath encapsulates the entire length of said capillary tube portion of said housing.

7. The apparatus recited in claim 4, including at least a second plug axially aligned and spaced from said first plug.

8. The apparatus recited in claim 4, including a plurality of indicia axially-arranged along the length of said plug that correlate with known absorption time intervals of said plug.

9. The apparatus recited in claim 1, wherein a first length of the capillary tube portion has a first inner diameter and a second portion has a second inner diameter different than the first inner diameter.

10. The apparatus recited in claim 1, wherein said first fluid exhibits the property of volume reduction upon cooling and changes to the solid state at T1.

11. The apparatus recited in claim 1, wherein said second fluid is miscible with said first liquid and has a solidification temperature lower than the solidification temperature of said first liquid.

12. The apparatus recited in claim 1, wherein the volume of said first liquid is greater than the volume of said reservoir prior to solidification, and is less than the volume of said reservoir upon solidification so that at least a portion of said second liquid is drawn into said reservoir upon solidification of said first liquid.

13. The apparatus recited in claim 1, wherein the volume of said reservoir portion is greater than the volume of said capillary portion.

14. The apparatus recited in claim 13, including an indicator in said first liquid that gives a visual indication that said first liquid has been contacted by said second liquid.

15. The apparatus recited in claim 13, including an indicator in said second liquid that gives a visual indication that said second liquid has been contacted by said first liquid.

16. The apparatus recited in claim 15, wherein said indicator comprises a dye dissolved within said second liquid that irreversibly changes the color of said first fluid when said fluids mix

17. The apparatus recited in claim 16, wherein at least the reservoir portion of said housing is made from a transparent material.

18. The apparatus recited in claim 1, wherein said first and second fluids comprise organic compounds.

19. The apparatus recited in claim 18, wherein said first and second fluids comprise fatty acid esters.

20. The apparatus recited in claim 1, wherein said separating means is an aqueous salt solution.
